(19) United States
(12) Patent Application Publication
(10) Pub. No.: US 2006/0252308 A1
(43) Pub. Date: Nov. 9, 2006

(54) Hazard boundary termination box

(75) Inventors: Jasbir S. Bhatia, Orlando, FL (US); Maurice A. Jenkins, Casselberry, FL (US)

Correspondence Address: Siemens Corporation;Intellectual Property Department, 170 Wood Avenue South, Iselin, NJ, 08830, US

(73) Assignee: Siemens Westinghouse Power Corp.

(21) Appl. No.: 11/122,570

(22) Filed: May 5, 2005

(51) Int. Cl. H01R 13/73

(52) U.S. Cl. 439/564

(57) ABSTRACT

A termination box, for maintaining an electrical connection across a boundary, can include a terminal block comprising a heat-resistant, non-conducive material having a first surface and a second surface. The first surface can include electrical terminals thereon connected to electrically conductive linkages passing through the terminal block and connecting to electrical terminals on the second surface of the terminal block. The termination box can also include a first cover and a second cover each having a cable conduit passing therethrough for receiving an electrical cable from the respective side of the boundary.

### FIELD OF THE INVENTION

The invention relates in general to electrical termination boxes and, more particularly, to termination boxes for providing electrical connectivity through boundaries.

### BACKGROUND OF THE INVENTION

In industry it is often important to maintain appropriate electrical connections between and among various electrical components. In certain applications maintaining an electrical connection is difficult due to the nature of the environment surrounding the electrical connection. Areas classified as hazardous pursuant to industry standards often contain boundaries for containing the hazardous environment or condition. With electrical components both inside and outside of the hazardous area, it is necessary to maintain the continuity of electrical termination as well as maintain the barrier between environments of the two different hazard zones.

One industry, for example, where electrical connections crossing hazardous boundaries are necessary is the power generation industry. In particular, combustion turbine power generation is one industry in which these hazardous barrier connections are necessary. Due to the extremely volatile conditions occurring in the turbine combustion chamber caused by intense heat, pressure and vibration, under normal conditions, combustion turbine power plant construction requires a sealed enclosure for the combustion turbine. The hazardous conditions in the turbine further necessitate that any electrical cables passing through the hazardous barrier be passed through cable conduits installed with seal fittings. These seal fittings, are generally expensive and time consuming to produce.

Installation of a proper seal fitting requires first, the proper positioning of the electrical cables passing through the cable conduit and second, the pouring of the sealant material to secure the cables in the cable conduit and seal the hazardous boundary barrier. The sealing material is generally a thermosetting polymer material that hardens in the cable conduit and creates a permanent electrical connection through the hazardous boundary barrier. Because of the permanency of the seal, there is very little room for error when creating the electrical connections. Once in place, the seal is very difficult to remove and replace without causing damage to the electrical connection. The process of forming the seals can be rather time consuming and cause extensive occurrences of maintenance downtime as the seals must be poured and set prior to operating the turbine. Such extended periods of maintenance downtime are both expensive and undesirable.

### SUMMARY OF THE INVENTION

Accordingly, there is a need to address the problems encountered in hazardous boundary crossings. Therefore, it is an object of the present invention to provide an electrical termination box for hazardous location boundary crossing. More specifically, there is a need for a hazard boundary crossing having a pass-through electrical connection which does not require permanent sealing of the electrical cables.

In an exemplary embodiment, the invention includes a boundary termination box including a terminal block having a non-conductive material, a first surface and an opposite second surface. The first surface can include at least one first electrical terminal and the second surface can include at least one second electrical terminal. An electrically conductive linkage can connect the first electrical terminal and second electrical terminal. A mounting member can be disposed on the terminal block for mounting the terminal block to a boundary. A first cover can be included for protecting the first surface and can include a first cable conduit for receiving a first electrically conductive cable for attachment to a first electrical terminal on the first surface. A second cover for protecting the second surface can include a second cable conduit for receiving a second electrically conductive cable for attachment to a second electrical terminal on the second surface.

In an embodiment according to aspects of the present invention, the terminal block can include a split-block, further including a first terminal block electrically connected to a second terminal block.

An embodiment according to aspects of the invention further includes a seal attached to the terminal block for sealing the block in a boundary opening and preventing the exchange of environmental conditions across the boundary.

Another aspect of the invention includes mounting the terminal block substantially flush with the boundary. To facilitate such a substantially flush mounting, the boundary can comprise a rabbeted edge around the opening of the boundary.

In an embodiment, the boundary comprises a hazardous boundary The hazardous boundary can be comprised in a turbine engine and the turbine engine can be utilized for power generation.

Aspects of the invention can include an internal electrical cable connected to the electrical connections on the internal surface of the internal terminal block and an external electrical cable connected to the electrical connections on the external surface of the external terminal block.

The electrical cables can be connected at a one end to the electrical terminals on the respective surfaces of the terminal block and at an opposite end to electrical components, such as, for example, controls, sensors, monitors, motors, pumps or any other electrical component.

Another aspect of the invention contemplates including indicia on the respective the electrical terminals for identification purposes. The indicia on an electrical terminal on the first surface of the terminal block can correspond to indicia on a connected electrical terminal on the second surface of the terminal block.

In another aspect of the invention aspect of the invention can include an securing the terminal block with a securing member selected from the group consisting of: screws; bolts; pins; rivets; anchors; or welded joints.

Further objects and advantages of the present invention will become apparent by reference to the following detailed disclosure of embodiments according to aspects of the invention and appended drawings where in like reference numerals refer to the same feature, component, or element.

### BRIEF DESCRIPTION OF THE DRAWINGS

FIG. 1 is a side plan cut away view, partially in phantom, of a single-block hazard boundary termination box embodiment according to aspects of the present invention.

FIG. 2 is a side plan cut away view, partially in phantom, of a split-block hazard boundary termination box embodiment according to aspects of the present invention.

FIG. 3 is a perspective view, partially in phantom, of an internal terminal block embodiment according to aspects of the present invention.

FIG. 4 is a perspective view of an external terminal block embodiment according to aspects of the present invention.

FIG. 5 is a side elevation view of an internal terminal block and external block embodiment according to aspects of the present invention.

### DETAILED DESCRIPTION OF EMBODIMENTS OF THE INVENTION

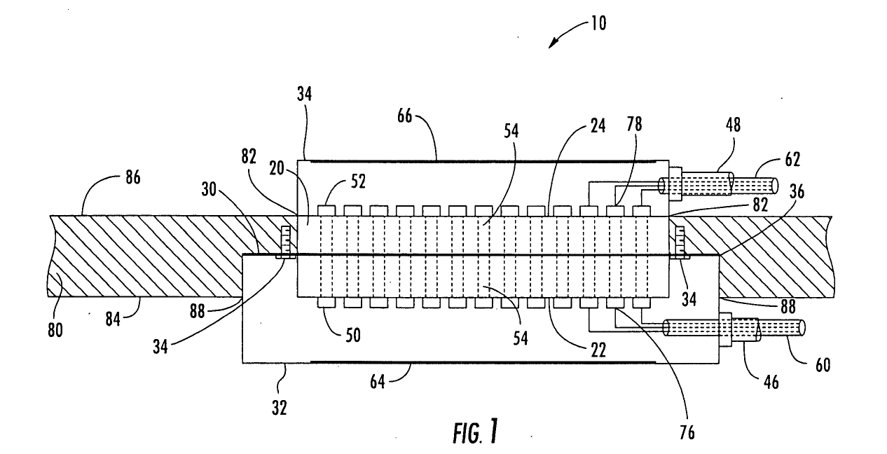

Referring now to FIG. 1, an exemplary boundary termination box according to aspects of the present invention is illustrated and generally referred to by reference numeral 10.

The boundary termination box 10 can comprise a terminal block 20, a mounting member 30, a first cover 32 and a second cover 34. The terminal block 20 can comprise a non-conductive material, a first surface 22 and an opposite second surface 24. The first surface 22 and second surface 24 of the terminal block 20 can each comprise at least one electrical terminal 50, 52 thereon, respectively. The electrical terminals 50, 52 can be connected by an electrically conductive linkage 54 therebetween. The mounting member 30 may be a plate that can be disposed on the terminal block 20 for mounting the terminal block 20 to a boundary 80. The mounting member 30 can comprise a seal 36 for sealing the terminal block 20 in the opening 82 of the boundary 80. The first cover 32 can protect the first surface 22 of the terminal block 20 and can include a first cable conduit 46 for receiving a first electrically conductive cable 60. The first electrically conductive cable 60 can be connected at an end 76 to at least one electrical terminal 50 on the first surface 22 of the terminal block 20 and connected at an opposite end (not shown) to a first electrical component (not shown). The second cover 34 can protect the second surface 24 of the terminal block 20. The second cover 34 can also comprise a second cable conduit 48 for receiving a second electrically conductive cable 62. The second electrically conductive cable 62 can be connected at an end 78 to at least one electrical terminal 52 on the second surface 24 of the terminal block 20 and connected at an opposite end (not shown) to a second electrical component (not shown). Electrical components can comprise, for example, sensors, displays, controllers, motors, or the like.

The hazard boundary termination box 10 can comprise a terminal block 20. The terminal block 20 can comprise a heat resistant, non-conductive material, a first surface 22 having at least one first electrical terminal 50 and an opposite second surface 24 having at least one second electrical terminal 52. Each first electrical terminal 50 on the first surface 22 of the terminal block 20 corresponds to and is electrically connected with a second electrical terminal 52 on the opposite second surface 24 of the terminal block 20.

The electrical terminals 50, 52 can be electrically connected together with an electrically conductive linkage 54 therebetween. The electrical terminals 50, 52 and the linkage 54 can comprise separate pieces, mechanically connected together, or single parts manufactured and mounted directly in the terminal block 20. The non-conductive material comprising the terminal block 20 can operate to insulate separate electrical terminals 50, 52 on the same respective surfaces 22, 24. In a preferred embodiment, the electrical terminals 50, 52 and the linkage 54 therebetween comprise highly conductive, compatible materials with increased corrosion tolerance.

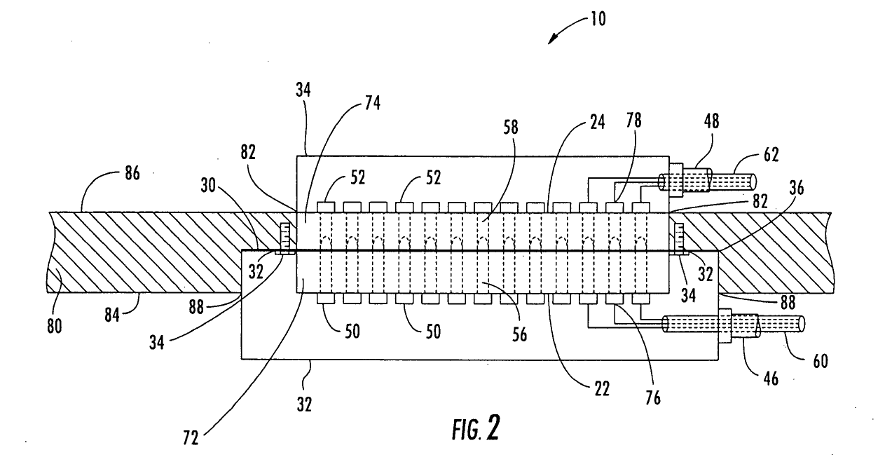

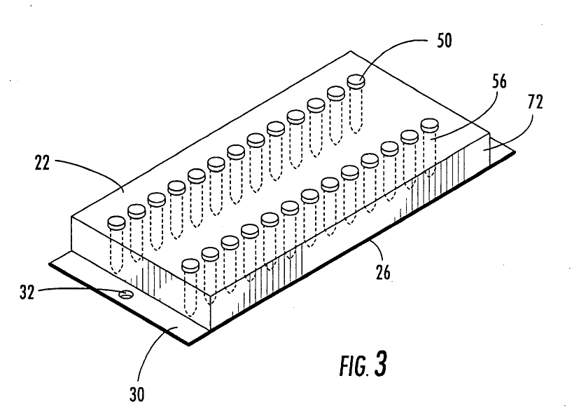

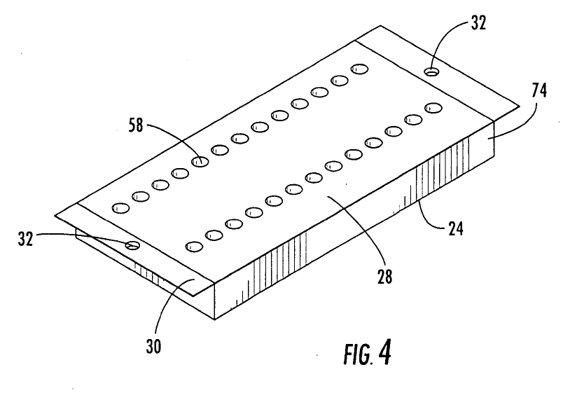

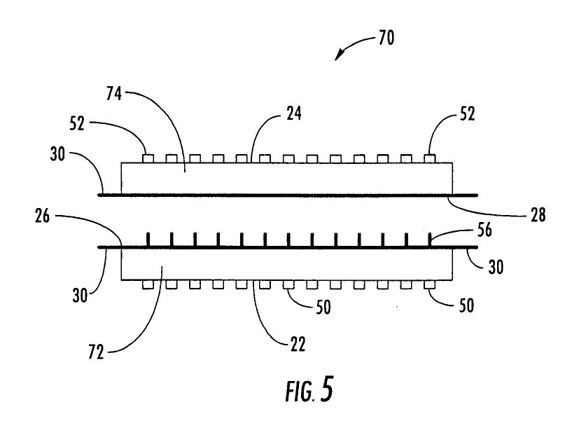

Referring now to FIGS. 2-5, in an alternative embodiment, the terminal block 20 can comprise a split-block arrangement 70 wherein the split-block 70 comprises two components, a first terminal block 72 and a second terminal block 74, electrically connected. The first terminal block 72 can comprise a first surface 22 and a first mating surface 26 for mating with, and electrically connecting to, the second terminal block 74. The second terminal block 74 can comprise a second surface 24 and a second mating surface 28 for mating with, and electrically connecting to, the first terminal block 72. Similar to the single-block arrangement, the first surface 22 of the first terminal block 72 can comprise at least one electrical terminal 50. The second surface 24 of the second terminal block 74 can also comprise at least one electrical terminal 52. The electrical terminals 50, 52 can be electrically connected together with male linkages 56 and complimentary female linkages 56 therebetween. When the mating surfaces 26, 28 are mated together, the male linkages 56 come into contact with the female linkages 58 to provide electrical connectivity between the electrical terminals 50, 52. In such an embodiment, the split-block 70 comprises the same or substantially similar features as the single-block terminal block 20.

In a split-block configuration 70, the terminal block 20 can comprise a first terminal block 72 and an second terminal block 74. The first mating surface 26 of the first terminal block 72 can comprise electrically conductive prongs, plugs or a combination thereof for connection to the second mating surface 28 of the second terminal block 74. The second mating surface 28 of the second terminal block 74 can comprise electrically conductive receptacles, sleeves or a combination thereof, complimentary to those on the first mating surface 26 of the first terminal block 72 and sufficient to establish a conductive electrical connection therebetween. In a preferred embodiment, the split-block configuration 70 comprises terminals 50, 52 that can be connected with mated linkages 56, 58. The mated linkages 56, 58 can comprise, for example, a plug and receptacle configuration. In another embodiment, the linkages 56, 58 can comprise pin an sleeve configurations. In general, the split-block 70 configuration can comprise linkages utilizing any configuration by which electrical conductivity is maintained between respective electrical terminals 50, 52.

The mounting member 30 can be connected to the terminal block 20, for attaching the terminal block 20 to the boundary 80. The mounting member 30 can be attached to the terminal block 20 in any position. For example, the mounting member 30 can be disposed at each end of the terminal block 20 and can comprise an opening 32 for receiving a securing member 34 for further mounting to the boundary 80. In an exemplary embodiment, the mounting member 30 is molded into the non-conductive material comprising the terminal block 20. In a further embodiment, the mounting member 30 can be disposed about the periphery of the terminal block 20.

When used with the split-block configuration 70, each terminal block 72, 74 can comprise a mounting member 30 for securing the mated terminal blocks 72, 74 in the opening 82 of the boundary 80. When both terminal blocks 72, 74 each comprise a mounting member 30, secured with a securing member 34, the mounting member can secure the position of the terminal blocks 72, 74 relative to one another as well as secure the position of the split-block 70 in the opening 82 of the boundary 80. In either the single-block configuration or the split-block configuration, the mounting member 30 can be secured to the first side 84, the second side 86 or a rabbet 88 in the boundary 80. As used herein a rabbet 88 is defined as a channel, groove, or recess cut into the boundary 80.

The securing member 34 can comprise any means sufficient for maintaining the position of the terminal block 20 in the boundary 80. Such means can include a screw, bolt, pin, rivet, anchor or any other like device. Other securing means such as, for example, welded joints can also be employed to maintain the connection between the mounting member 30 and the boundary 80.

The termination box 10 can comprise a block seal 36 disposed about the terminal block 20 for forming a seal between the terminal block 20 and the opening 82 of the boundary 80. Such a configuration can impede the passing of undesired environmental conditions from one side of the boundary 80 to the other. In a preferred embodiment, the seal 36 is complementary to the mounting member 30 and is sufficient to completely inhibit any exchange of environmental conditions across the boundary 80. In one aspect of the invention, the block seal 36 can comprise a thermosetting polymer material or other material capable of forming a seal sufficient to withstand and maintain the hazardous environment on one side of the barrier 80.

To protect the first surface 22 of the terminal block 20 and any electrical terminals 50 contained thereon, a first cover 32 can be utilized. The first cover 32 generally comprises a highly heat resistant, non-conductive, material and can be removably attached to the boundary 80 for access to the terminal block 20. Passing through the first cover 32 can be a first cable conduit 46 through which a first electrically conductive cable 60 can pass. The conductive ends 76 of the first electrically conductive cable 60 can be connected to electrical terminals 50 attached to the first surface 22 of the terminal block 20. The second cover 34 generally also comprises a highly heat resistant, non-conductive, material and can be removably attached to the boundary for access to the single-block terminal block 20 or the split-block terminal block 70. Passing through the second cover 44 is a second cable conduit 48 through which a second electrically conductive cable 62 can pass. The conductive ends 78 of the second electrically conductive cable 62 can be connected to electrical terminals 52 attached to the second surface 24 of the terminal block 20.

In an embodiment, the second cover 44 can comprise a lipped edge (not shown) wherein the second cover 44 is of a size and shape complimentary to the opening 82 of the boundary 80 and the lipped edge (not shown) is of a size and shape complimentary to the mounting member 30 and/or a rabbet 88 in the boundary 80. The lipped edge (not shown) can further comprise an opening (not shown) complimentary to the opening 32 of the mounting member 30, for receiving a securing member 34 and attachment to the boundary 80.

In an additional embodiment, either or both covers 32, 34 can comprise access members 64, 66 for accessing the respective surface 22, 24 of the terminal block 20. Such access can assist in facilitating maintenance to the terminal block 20 without requiring disassembly of the termination box 10.

A purpose of the termination box is to provide electrical continuity across a barrier 80. Electrical continuity can comprise the passing of an electrical charge as well as the passing of an analog or digital signal through electrically conductive cables 60, 62. To facilitate this electrical continuity, electrical cables 60, 62 can enter the termination box on respective sides of a boundary through cable conduits 46, 48 passing through the respective covers 42, 44. The cable conduits 46, 48 can serve both as an entry point through which electrically conductive cables 60, 62 can pass and a means by which the respective cables' 60, 62 position can be maintained. For example, the first electrically conductive cable 60 can fit snugly into the first cable conduit 46 and prevent the cable 60 from backing out of the cable conduit 46 thereby severing the connection with the respective electrical terminal 50.

On the first surface 22 and second surface 24 of the terminal block 20 adjacent to each electrical terminal 50, 52 can be a label or other means of identification to individually identify each respective electrical terminal 50, 52. By way of example, one function of the individual identification of the electrical terminals 50, 52 on the respective surfaces 22, 24 of the terminal block 20 is to assist the user of the terminal box 10 in establishing the appropriate electrical connections across the barrier 80. Identification means can include labels, plates, engravings, etchings or any other like means sufficient to identify individual electrical terminals.

Following are examples illustrating procedures for practicing aspects of the invention. These examples should not be construed as limiting, but should include any and all obvious variations as would be readily apparent to a skilled artisan.

In a turbine engine with a boundary 80, such as a hazard boundary 80 of an electrical component, the first electrically conductive cable 60 can be passed through a first cover 42 of the termination box 10 via a first cable conduit 46. The ends 76 of the first electrically conductive cable 60 can be connected to labeled electrical terminals 50 disposed on the first surface 22 of the terminal block 20. From the second side 86 of the boundary 80, a second electrically conductive cable 62 can be passed through the second cover 44 of the termination box 10 through a second cable conduit 36. The ends 78 of the second electrically conductive cable 62 can be, for example, attached to identically labeled electrical terminals 52 disposed on the second surface 24 of the terminal block 20. The opposite ends (not shown) of the second electrically conductive cable 62 can then further be attached to an electrical component, such as, for example, a display (not shown) for receiving the input from the aforementioned sensor (not shown).

In a split-block 70 configuration, an electrical component, such as, for example, a sensor (not shown) located on a first side 84 of the boundary 80, can be attached to at least one end 76 of a first electrically conductive cable 60. The first electrically conductive cable 60 can be passed through a first cover 42 of the termination box 10 via a first cable conduit 46. The ends 76 of the first electrically conductive cable 60 can be connected to labeled electrical terminals 50 disposed on the first surface 22 of the first terminal block 72. The electrical terminals 50 can be connected to male linkages 56 passing through the first terminal block 72 and protruding from the first mating surface 26. The first mating surface 26 is mated to a second mating surface 28 on a second terminal block 74. The second mating surface 28 comprises female linkages 58 passing through the second terminal block 74 and connected to electrical terminals 52 on the second surface 24 of the second terminal block 74. From the second side 86 of the boundary 80, a second electrically conductive cable 62 can be passed through the second cover 44 of the termination box 10 through a second cable conduit 36. The ends 78 of the second electrically conductive cable 62 can be, for example, attached to identically labeled electrical terminals 52 disposed on the second surface 24 of the second terminal block 74. The opposite ends (not shown) of the second electrically conductive cable 62 can then further be attached to an electrical component, such as, for example, a display (not shown) for receiving the input from the aforementioned sensor.

The termination box 10 can be mounted in the opening 82 of the boundary 80 so the first surface 22 and second surface 24 of the terminal block 20 are substantially flush with the first surface 84 and second surface 86, respectively, of the boundary 80. To facilitate such an arrangement, the boundary 80 may comprise a rabbet 88 wherein the opening 82 in the boundary 80 is complimentary to the size and shape of the terminal block 20 and surrounding second cover 44 and the rabbet 88 in the boundary 80 is complementary to the shape and size of the mounting member 30.

Because of the identical markings (not shown) corresponding to the electrical terminals 50, 52 on both sides of the barrier 80, the electrically conductive cables connected thereto can be attached to the respective surfaces 22, 24 of the terminal block 20 in a manner just as if a cable passed through the barrier 80 uninterrupted. Such a feature significantly reduces the amount of time required to establish electrical connections, create seals, and ready the turbine for operation.

As an illustrative example, the first three electrical terminals on the internal terminal block internal surface 42 can be labeled 1, 2, and 3. These electrical terminals can correspond to red, white and green electrical wires from the internal electrical cable 60. The electrical terminals on the external terminal block external surface 48 comprise identical markings and therefore allow the corresponding red, white and green cables to be attached to terminals 1, 2 and 3 respectively from the external cable. Such identification markings significantly reduce the chance of cross wiring or shorting out an electrical component.

Inasmuch as the proceeding disclosure presents the best mode devised by the inventor for practicing the invention and is intended to enable one skilled in the pertinent art to carry it out, it is apparent that structures and methods incorporating modifications and variations will be obvious to those skilled in the art. As such, it should not be construed to be limited thereby but include such aforementioned obvious variations and be limited only by the spirit and scope of the following claims.

1. A boundary termination box comprising:
a terminal block comprising a non-conductive material, a first surface and an opposite second surface, said first surface comprising at least one first electrical terminal and said second surface comprising at least one second electrical terminal thereon;
an electrically conductive linkage connecting said at least one first electrical terminal and said at least one second electrical terminal;
a mounting member disposed on said terminal block for mounting said terminal block to a boundary;
a first cover for protecting said first surface, said first cover comprising at least one first cable conduit for receiving at least one first electrically conductive cable for attachment to said at least one first electrical terminal on said first surface;
a second cover for protecting said second surface, said second cover comprising at least one second cable conduit for receiving at least one second electrically conductive cable for attachment to said at least one second electrical terminal on said second surface as
a seal attached to an outer surface of said terminal block and exposed to seal said block in a boundary opening and preventing the exchange of environmental conditions across the boundary opening by contacting the terminal block and the boundary opening.

2. The termination box of claim 1 wherein said terminal block comprises a split-block, further comprising a first terminal block electrically connected to a second terminal block.

3. (canceled)

4. The termination box of claim 1 wherein said terminal block is mounted substantially flush with said boundary.

5. The termination box of claim 4 wherein said boundary comprises an opening further comprising a rabbet.

6. The termination box of claim 1 wherein said boundary is a hazardous boundary.

7. The terminal box of claim 6 wherein said hazardous boundary is comprised in a turbine engine.

8. The termination box of claim 1 wherein each of said electrical cables is connected at a one end to respective electrical terminals and at an opposite end to an electrical component.

9. The termination box of claim 8 wherein said electrical component is selected from the group consisting of: a monitor, a controller, a motor and a sensor.

10. The termination box of claim 1 wherein the at least one first electrical terminal on said first surface of said terminal block contains identification indicia and wherein said identification indicia corresponds to one of said at least one second electrical terminals on the second surface of said terminal block.

11. The termination box of claim 1 wherein said mounting member is secured to said boundary by at least one securing member selected from the group consisting of: a screw; a bolt; a pin; a rivet; an anchor and a welded joint.

12. A termination box for providing electrical connectivity across a boundary comprising:
a terminal block comprising a heat-resistant, non-conducive material, a first surface and an opposite second surface, said first surface comprising at least one first electrical terminal and said second surface comprising at least one second electrical terminal thereon;
an electrically conductive linkage connecting said at least one first electrical terminal and said at least one second electrical terminal;
a mounting member disposed on said terminal block for mounting said terminal block to a boundary;
a seal attached to an outer surface of said terminal block and exposed to seal said block in a boundary opening and preventing the exchange of environmental conditions across the boundary opening by contacting the terminal block and the boundary opening;
a first cover for protecting said first surface, said first cover comprising at least one first cable conduit for receiving at least one first electrically conductive cable for attachment at an end to said at least one first electrical terminal on said first surface and attachment at an opposite end to a first electrical component; and
a second cover for protecting said second surface, said second cover comprising at least one second cable conduit for receiving at least one second electrically conductive cable for attachment at an end to said at least one second electrical terminal on said second surface and attachment at an opposite end to a second electrical component.

13. The termination box of claim 12 wherein said terminal block comprises a split-block, further comprising a first terminal block electrically connected to a second terminal block.

14. The termination box of claim 12 wherein said boundary is a comprised in a turbine engine.

15. The termination box of claim 14 wherein said first and second electrical components are selected from the group consisting of: a monitor, a controller, a motor and a sensor.

16. The termination box of claim 12 wherein the first electrical terminals on the first surface of said terminal block comprise identification indicia, said indicia corresponding to a connected second electrical terminals on the second surface of said terminal block.

17. The termination box of claim 12 wherein said mounting member is secured to said boundary by at least one securing member selected from the group consisting of: a screw; a bolt; a pin; a rivet; an anchor and a welded joint.

18. A termination box for providing electrical connectivity across a boundary in a turbine engine comprising:
a terminal block comprising a heat-resistant, non-conducive material, a first surface and an opposite second surface, said first surface comprising at least one first electrical terminal and said second surface comprising at least one second electrical terminal thereon;
an electrically conductive linkage connecting said at least one first electrical terminal and said at least one second electrical terminal;
a mounting member disposed on said terminal block for mounting said terminal block to a boundary;
a seal attached to an outer surface of said terminal block and exposed to seal said block in a boundary opening and preventing the exchange of environmental conditions across the boundary opening by contacting the terminal block and the boundary opening;
a first cover for protecting said first surface, said first cover comprising at least one first cable conduit for receiving at least one first electrically conductive cable for attachment at an end to said at least one first electrical terminal on said first surface and attachment at an opposite end to a first electrical component; and
a second cover for protecting said second surface, said second cover comprising at least one second cable conduit for receiving at least one second electrically conductive cable for attachment at an end to said at least one second electrical terminal on said second surface and attachment at an opposite end to a second electrical component;
wherein said terminal block comprises a split-block, further comprising a first terminal block electrically connected to a second terminal block.

19. (canceled)

20. The termination box of claim 18 wherein said mounting member is secured to said boundary by at least one securing member selected from the group consisting of: screws, bolts, rivets, pins and welded joints.
